(19) United States
(12) Patent Application Publication
(10) Pub. No.: US 2014/0123909 A1
(43) Pub. Date: May 8, 2014

(54) VIBRATORY TOY THAT DETERS TIPPING OVER YET SELF-RIGHTS ITSELF WITHIN A CONTAINER

(71) Applicants: John Balogh, Chicago, IL (US); Mark Le Van, Waukegan, IL (US)

(72) Inventors: John Balogh, Chicago, IL (US); Mark Le Van, Waukegan, IL (US)

(21) Appl. No.: 14/058,289

(22) Filed: Oct. 21, 2013

Related U.S. Application Data
(60) Provisional application No. 61/716,665, filed on Oct. 22, 2012.

(51) Int. Cl. A01K 15/02

(52) U.S. Cl. CPC A01K 15/025
USPC 119/707

(57) ABSTRACT

A vibratory activity toy that includes a unit with a housing having an underside and a topside. A vibratory motor is accommodated by the housing and is operative to impart vibratory forces to the housing so as to effect vibration that urges the housing to move about on a flat surface in an upright position with the topside being at a higher elevation than the underside. Tipping of the unit on the flat surface is prevented during the vibration by a widened locomotion bar piece. The unit self-rights itself to the upright position on the flat surface due to the configuration of the housing that include three spaced apart rounded surfaces that protrude from the topside of the housing.

### CROSS-REFERENCE TO COPENDING PATENT APPLICATIONS

The present application has the benefit of invention priority from U.S. provisional patent application Ser. No. 61/716,665 filed Oct. 22, 2012, whose contents are incorporated herein in its entirety.

### BACKGROUND OF THE INVENTION

1. Field of the Invention

An activity toy for cats that includes a vibratory or vibrating motorized toy mouse with random movements that mimic a real mouse moving inside of a round container with viewing holes. The round container resembles a Swiss cheese wheel. Mouse stays inside the container so cat doesn't ingest the mouse.

2. Discussion of Related Art

Kittens are programmed at birth with hunting and chasing instincts which their mother expands on so they will have the skills to feed themselves. Domesticated cats are well fed so they do not need to hunt to survive but they retain their hunting instincts. The way that they play is based on these traits. This is the product of thousands of years of evolution. Domesticated cats still need to express this natural behavior for better physical and mental health. They can become bored and lazy.

Cats have very sensitive, finely tuned directional hearing. You will see them move their ears around like satellite dishes to determine where a sound is originating. Cats have superior vision. They can see in a panoramic view due to their ability to dilate their pupils. This gives them excellent peripheral vision.

Hence the motivation for devising the vibratory toy mouse that self-rights itself within a container that is reminiscent of a Swiss cheese wheel, which may be identified as a Cheesy Mouse Hunt apparatus.

### SUMMARY OF THE INVENTION

The Cheesy Mouse Hunt apparatus is designed to work with the cat's natural hunting instincts and their superior senses. Small rodents are cats' normal prey. The mouse in our toy mimics the movements and sounds that a mouse makes foraging for food. This immediately gets the felines attention and draws them to the cheese round. The challenge of the mouse in the cheese round keeps their attention. They can reach in but can't quite get a hold of the mouse. When you make it difficult for them to get to the prey/toy . . . it gets them fired up!

| Feature | Benefit |
|---|---|
| Motorized Mouse (Sight) | Movement mimics natural rodent |
| | behavior that visually attracts the cats' |
| | attention. |
| Motorized Mouse (Sound) | The sound of the mouse bouncing |
| | around in the cheese attracts the cats' |
| | attention. |
| Cheese Round With Holes To | Adds challenge to keep the cats |
| See Inside | engaged and to have fun with play. |

The vibratory toy mouse is equipped with provisions for anti-tipping and for self-righting to an upright position. The anti-tipping feature includes a relatively wide locomotion bar toward the front of the vibratory toy mouse. The self-righting feature includes three spaced apart rounded surfaces, which may be considered points of a triangle. They are located at the topside of each of two ears and the top side of the back of a toy mouse. By analogy, other configurations instead of a mouse shape may be used where the three rounded surfaces on the top surface are provided in the same relative position as in the case for the toy mouse.

### BRIEF DESCRIPTION OF THE DRAWING

For a better understanding of the present invention, reference is made to the following description and accompanying drawings, while the scope of the invention is set forth in the appended claims.

FIG. 1A is an top plan view of a topside of a bottom shell of a vibratory motor shell containing a conventional vibratory motor in accordance with a first embodiment of the invention.

FIG. 1B is a top plan view of the underside of a top shell of the vibratory motor shell in accordance with the first embodiment of the invention of FIG. 1.

FIG. 1C is a right side plan view, which is symmetric to the left side plan view, of an exterior toy mouse housing containing an assembly of the vibratory shells of FIGS. 1A and 1B.

FIG. 2A is an isometric view of a vibratory toy mouse body piece in accordance with a second embodiment that has an opening.

FIG. 2B is an isometric view of a vibratory toy mouse two-ear piece in accordance with the second embodiment of FIG. 2A.

FIG. 2C is an isometric view of a vibratory toy mouse front bar piece in accordance with the second embodiment of FIGS. 2A and 2B.

FIG. 2D is an isometric view of an assembly of the vibratory toy mouse housing with the two-ear piece of FIG. 2B snapped into the opening in the body piece of FIG. 2A and having the font bar piece of FIG. 2C secured into its position.

FIG. 3A is an exploded view of all the plastic parts of the vibratory toy mouse assembly separated from each other in accordance with the second embodiment of FIGS. 2A-2d.

FIGS. 3B and 3C are progressive assembly views showing the manner of assembling the vibratory toy mouse of the second embodiment of FIGS. 2A, 2B, 2C, 2D and 3A.

FIGS. 4A and 4B are different isometric views of the top and side of a container in accordance with a third embodiment.

FIG. 4C is a top view of the container of FIGS. 4A and 4B containing the vibratory toy mouse of the second embodiment, but with the vibratory toy mouse having an imitation fur overlay over its body.

FIG. 5 is an isometric view of the vibratory toy mouse in accordance with a third embodiment.

FIG. 6 is an isometric view of various components of a conventional radio controlled toy race car kit.

### DESCRIPTION OF THE PREFERRED EMBODIMENT

For a better understanding of the present invention, reference is made to the following description and accompanying drawings, while the scope of the invention is set forth in the appended claims.

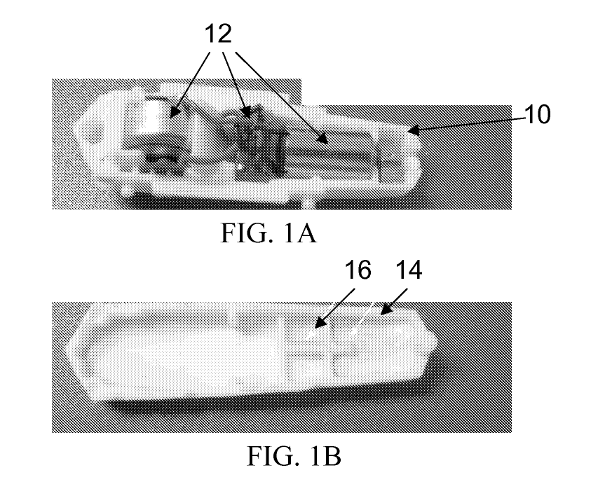

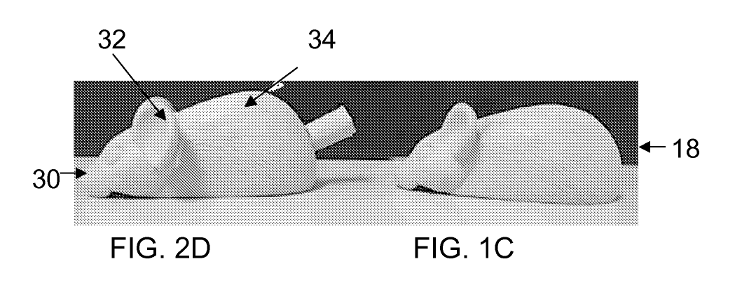

Turning to the drawing, FIGS. 1A-1C show a vibratory mouse in accordance with a first embodiment. The vibratory mouse includes molded top and bottom plastic shells 10, 14 that are recessed internally to accommodate housing within a conventional vibratory motor mechanism 12 upon joining the peripheries of the top and bottom plastic shells 10, 14 together. Internal ribs 16 are formed in the inside surface of the shell 14 to help hold the vibratory motor mechanism 12 in position. The entire housed vibratory motor assembly of FIGS. 1A and 1B fits within the inside recess of the molded plastic mouse housing 18 of FIG. 1C via the open bottom of the molded plastic mouse housing 18. The reason for the strategically placed ears and the rounded corners of the front bar of the molded plastic mouse housing 18 is enable the feature of uprighting. Also the location of the vibratory motor mechanism 12 provides a low center of gravity. The vibratory motor mechanism 12 itself may be purchased conventionally in its own plastic housing and has a switch that is used to turn its vibrating motor on or off.

Features of the vibratory mouse include: (a) 2-30 degree wedge-section locomotion bars located front and back and when vibrated, move the mouse forward with a series of very small fast hops; (b) for optimum forward movement, the back bar is located as far back as possible and the front bar is located 37 percent of the length back from the nose, which also places it directly under the center of the vibrator motor; (c) the ears are positioned in relation to the rounded-corner front bar to create a general arc when the mouse is rolled laterally so that with the low center of gravity placement of the mechanism's weight is enough to upright itself during vibration, and (d) the cheese with viewing holes has an inside semi smooth surface that the mouse moves upon so as to provide a non-skid hard surface to promote the best motion forward.

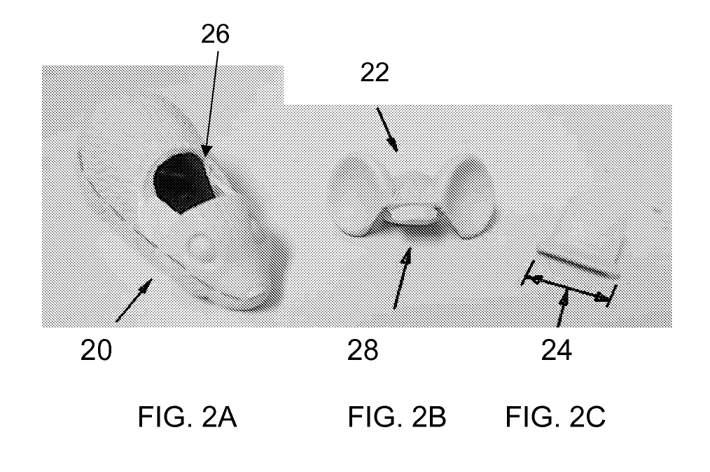

Turning to FIGS. 2A-2D, one can appreciate that enlarging the mouse ears 32 beyond that of the mouse ears of FIG. 1C as well as increasing the height of the back 34 beyond that of the back of FIG. 1C help the mouse balance its weight so it doesn't take as much energy to upright when flipped over 180 degrees from its upright position. A small drop of crazy glue is to be used on the front and back bar to hold it in place. FIGS. 2A and 2B show two separate pieces, namely, a body piece 20 and a two-ear piece 22, respectively, which are provided and joined together to form the mouse housing 30 of FIG. 2D. The body piece 20 may have an opening 24 into which is fitted a projection 26 from the central region of the two-ear piece 22. A bar piece 28 is provided that is secured to the underside of the body piece 20. By widening the front bar of the bar piece 28 to the extent shown in FIG. 2C and keeping its edge straight rather than curved, the vibratory mouse of FIGS. 2A-2D is less likely to tip over than is the case for the embodiment of FIGS. 1A-1C.

Preferably the body piece 20 and the two-ear piece 22 are made of a rigid styrene material, while the front and back bars of the bar piece 28 are made of a semi-rigid TPE material and the mouse tail is made of a softer material.

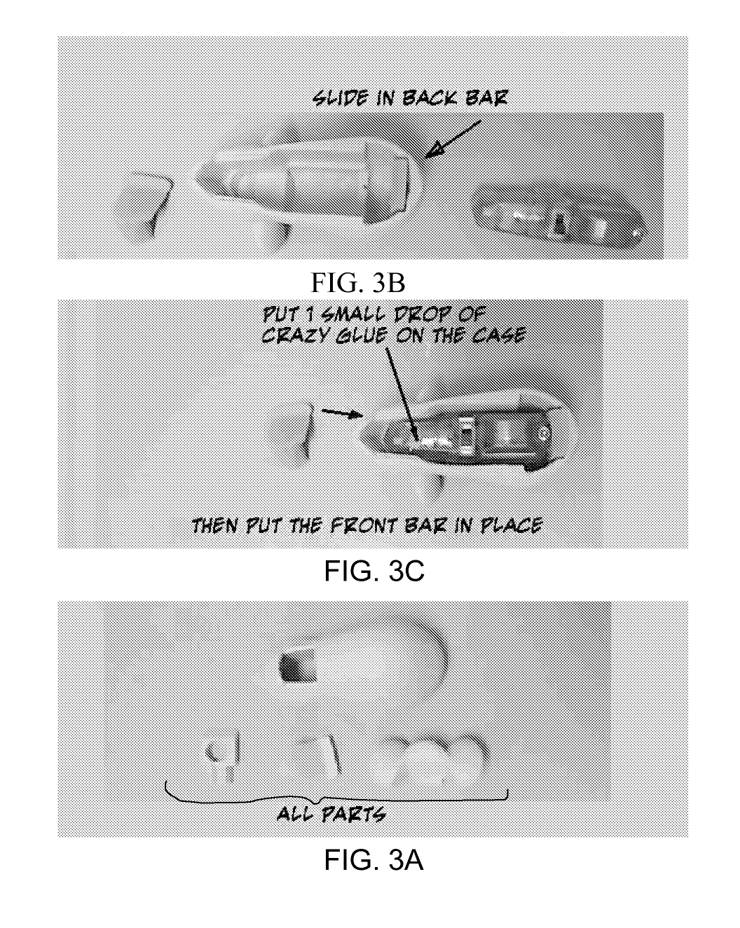

Turning to FIGS. 3A -3C, the assembly of the components in shown. In FIG. 3A, all the plastic components are shown. In FIG. 3B, the manner of sliding in the back bar is shown. In FIG. 3C, the manner of attaching the inserted vibratory motor mechanism is shown, i.e., by adding glue. The front bar is then put in place. Note that the two-ear piece snaps into place in the opening in the body part of the mouse.

The front bar needs only a tiny bit of crazy glue to hold it to the top of the vibrator housing. This drop of glue should go on center under the blade part where it touches the vibrator housing.

TPE is fine to use for molding the front and back bars. Regarding securing the mouse: If you use electrical ties to hold the mouse securely in the package, make sure that the front and back bars are free floating in the package. If there is pressure on the bars they may deform over time in the package.

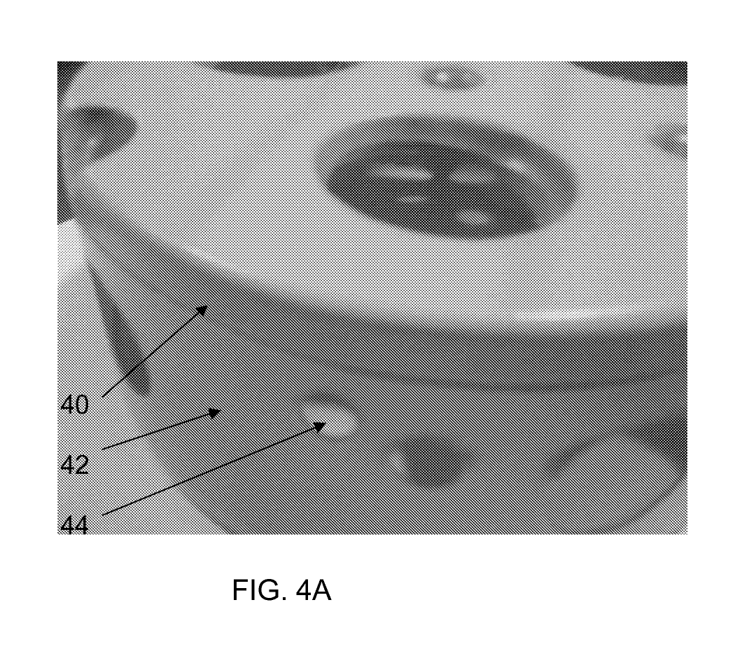

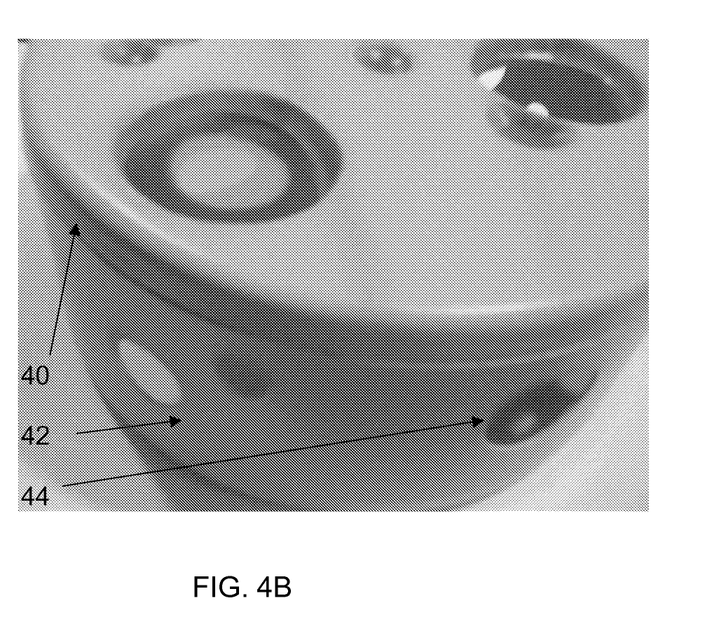

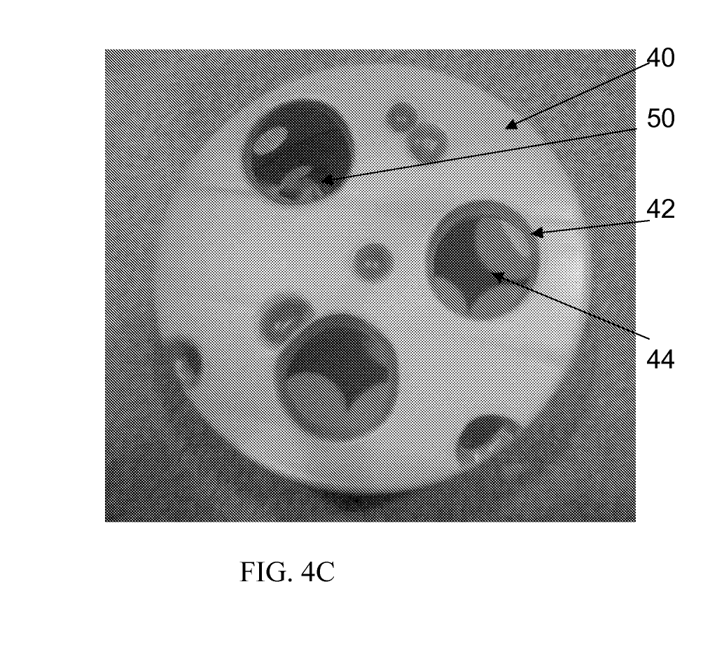

Turning to FIGS. 4A to 4C, a container for the vibratory mouse is depicted. The container is made of a durable plastic material that defines a hollow shape with openings. The openings allow one to see the interior of the container from outside the container and to insert the vibratory mouse into the container or pull out the mouse.

The overall shape of the container is reminiscent of a Swiss cheese wheel. The vibratory mouse 50 of any of the embodiments is free to move around within confines of the container and is confined by the container against leaving on its own. There are a plurality of openings 44 located in a somewhat random manner in the top and side. The bottom surface is flat and has no openings.

If desired, the container could have transparent or translucent portion in place of the holes. The container may have two halves, namely an upper lid portion 40 and a lower base portion 42 that screw or otherwise fasten to each other in a releasable manner to provide access to the interior to insert or remove the vibratory mouse.

The mouse moves best going in a counter clockwise direction inside the round base.

While the housing for the activity toy is that of a mouse, the housing instead may be of any other animal as long as it accommodates the vibrating motorized unit and has the same anti-tipping means and self-righting means. The container may be changed with respect to its shape and appearance in any desired manner so long as it provides the ability to see into its interior and to provide access to the interior from placement or removal of the mouse.

One might put multiple vibratory activity toys (e.g., mice) within the container and watch the effect to their respective movement as they bump into each other over time.

A 1/16″ thick×6″ diameter disc of polycarbonate or acrylic (similar to a CD disc) should be adhered well to the inside facing bottom of the cheese wheel container. Another good material may be some type of Formica plastic laminate or phenolic circuit board material.

About 10% of the mice uprighted and rode on the side of the shell. That could be because all the mice are hand made and some perform better than others. However the bar could be made a bit wider or less rounded to keep upright.

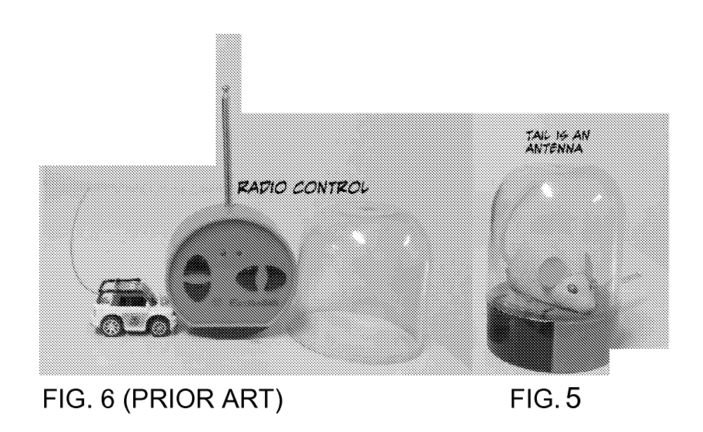

FIG. 5 shows an alternative arrangement in which the toy mouse may be remote controlled to vibrate or stop with its tail being an antenna to receive signals from a handheld radio control unit that transmits signals to that effect. The remote control aspect is analogous to a conventional radio controlled toy racecar (see FIG. 6) in that the racecar responds to received signals from a handheld radio control unit to move forward, move in reverse or stop.

While the foregoing description and drawings represent the preferred embodiments of the present invention, it will be understood that various changes and modifications may be made without departing from the scope of the present invention.

What is claimed is:

1. A vibratory activity toy, comprising a unit that includes a housing having an underside and a topside, a vibratory motor accommodated by the housing operative to impart vibratory forces to the housing so as to effect vibration that urges the housing to move about on a flat surface in an upright position with the topside being at a higher elevation than the underside, anti-tipping means for preventing tipping of the unit on the flat surface during the vibration, and self-righting means for self-righting the unit from a non-upright position to the upright position on the flat surface, the anti-tipping means including locomotion bars that protrude from the underside of the housing, the self-righting means including rounded surfaces that protrude from the topside of the housing.

2. The vibratory activity toy of claim 1, wherein the housing is elongated between front and back, the anti-tipping means includes front and rear locomotion bars that project from the underside of the housing with the rear locomotion bar being closer to the rear of the elongated housing than to the front of the elongated housing and the front locomotion bar being closer to the front of the housing than to the rear of the elongated housing.

3. The vibratory activity toy of claim 2, wherein the unit has a center, the front locomotion bar projecting in a direction that is in alignment with the center.

4. The vibratory activity toy of claim 2, wherein the unit has a weight and has a center of gravity, the self-righting means including rounded surfaces positioned in relation to the front locomotion bar to create a general arc when the housing rolls laterally to urge the unit to self-right to the upright position because of contributions to do so from a location of the center of gravity of the unit, the weight of the unit and the general arc created during rolling of the housing.

5. The vibratory activity toy of claim 1, further comprising a container having a top, bottom and side, the container having holes or being transparent or translucent.
